(19) United States
(12) Patent Application Publication
(10) Pub. No.: US 2005/0008737 A1
(43) Pub. Date: Jan. 13, 2005

(54) Absorbent pad for absorbing liquid exuding from food

(76) Inventor: Young-Won Kwon, Goyang-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/802,279

(22) Filed: Mar. 16, 2004

(30) Foreign Application Priority Data
Jul. 7, 2003 (KR) 10-2003-0045594
Oct. 27, 2003 (KR) 10-2003-0074953

(51) Int. Cl. A23B 4/00

(52) U.S. Cl. 426/124

(57) ABSTRACT

The present invention relates to an absorbent pad for use in wrapping food, which is placed between food and a food container so as to absorb and store the liquid exuding from food. This absorbent pad for absorbing the liquid exuding from food includes an upper sheet, a lower sheet and an absorbent material layer placed in-between. The absorbent material layer is made from a pulp, a thermally active fiber, an antibacterial agent and an absorbent resin and bonded to each other, and the absorbent resin is at least one material selected from an absorbent short fiber, a powdery absorbent resin and a granular absorbent resin. Since the absorbent material layer of the inventive absorbent pad contains the thermally active fiber together with the pulp and the absorbent resin, the absorbent materials in the absorbent material layer can be effectively prevented from flowing out of the absorbent pad even when the absorbent material layer swells by absorbing the liquid exuding from foods.

### BACKGROUND OF THE INVENTION

1. Field of the Invention

The present invention relates to food processing. More particularly, the present invention relates to an absorbent pad for use in food processing.

2. Background of the Related Art

Generally when the cells of foods, such as meats, fishes, vegetables and fruits, are broken, the liquid inside and outside the cells exudes out so that the freshness of foods is lowered. If the freshness of foods is lowered, the water retention ability of the foods will be decreased so that a larger amount of liquid (exudates) will ooze out from the foods to further accelerate the self-decomposition and discoloration of the foods and the proliferation of bacteria in the foods.

In order to maintain the freshness of food, there is a widely used a method wherein the liquid exuding from food is absorbed by an absorbent pad to separate the exuded liquid from the food.

If an absorbent pad made of paper or sponge is used, food and the liquid exuding from the food apparently seem to be separated, but they will be actually in contact with each other such that the freshness of the food can not be kept.

Recently, in order to keep food and the liquid exuding from the food in a separated state and thus to further increase the freshness of the food, an absorbent pad consisting of an upper sheet, a lower sheet and an absorbent material layer interposed in-between is proposed and widely used.

Concretely, for example, Korean patent laid-open publication No. 1992-2324 discloses an absorbent pad in which powdery or granular edible sugar is placed between a semi-permeable membrane and a water-absorbable porous sheet. Korean patent laid-open publication No. 1990-3038 discloses an absorbent pad in which absorbent materials, such as pulps and/or carboxymethyl celluloses, are placed between an upper sheet and a lower sheet. Korean patent laid-open publication No. 1999-87164 discloses an absorbent pad comprising upper and lower sheets which are bound to each other in such a manner as to form at least one cell, the cell having an absorbent material therein, at least one of the sheets being made of a liquid-impermeable material having fine perforations.

The prior absorbent pads comprise the powdery or granular absorbent material (absorbent resin) located between the upper and lower sheets, and thus are advantageous in that they allows the liquid exuding from foods to be absorbed and kept in a state separated from the foods. However, they have a problem in that when the absorbent material swells by absorbing the liquid exuding from foods, the absorbent material is liable to flow out of the absorbent pad.

Meanwhile, U.S. Pat. No. 5,176,930 granted on Jan. 5, 1993 discloses an absorbent pad for use in a food package comprising (1) upper and lower layers of normally liquid impervious material, (2) an intermediate layer of absorbent material disposed between said upper and lower layers for absorbing liquids exuded from a food product, and (3) means securing said upper and lower layers and said first portion of said intermediate layer, said intermediate layer comprising first and second superposed portions, said first portion extending outwardly to the periphery of said pad between said upper and lower layers to wick liquids exuded from a food product into said pad, said second portion being confined wholly within the interior of said pad between said upper and lower layers.

Also, U.S. Pat. No. 5,320,895 granted on Jun. 14, 1994 discloses an absorbent product for absorbing liquids bleeding from food items derived from animals comprising (1) a core including a mat of absorbent material; (2) an upper sheet and a lower sheet situated on opposite sides of said mat; and (3) means for drawing liquid into said core from the exterior of said product through the outwardly directed openings in said lower sheet, said product being perforated throughout with a plurality of perforations extending through both of said sheets and said mat, said perforations forming inwardly directed openings in said upper sheet, outwardly directed openings in said lower sheet, and channels extending through said mat, wherein each perforation comprises one of said inwardly directed openings, one of said outwardly directed openings, and one of said channels, wherein said openings and said channel of each perforation are collinear.

The prior absorbent pads have absorbed the liquids exuded from the food product through a plurality of perforations which were perforated through the upper and lower layers and the intermediate layer of absorbent material, and were invented for increasing the capability of absorbing liquids exuded from the edges thereof. Therefore, they have also a problem in that an individual perforated process was required at the time of preparing of the absorbent pads, and when the absorbent material swells by absorbing the liquid exuding from foods, the absorbent material is liable to flow out of the absorbent pad.

Another problem is that they cannot rapidly absorb the liquid exuding from foods (i.e., they have slow absorption rate) such that the freshness of the foods being stored is deteriorated. For this reason, the absorbent resin flowed out of the absorbent pad will be in direct contact with foods being stored, to reduce the freshness of the foods and also modify the foods, thereby making the foods harmful to the human body.

### SUMMARY OF THE INVENTION

Accordingly, the present invention has been made to solve the above-mentioned problems occurring in the prior art, and an object of the present invention is to provide an absorbent pad for absorbing the liquid exuding from foods, in which absorbent materials in an absorbent material layer can be effectively prevented from flowing out of the absorbent pad even when, the absorbent material layer swells by absorbing the liquid exuding from foods, and in which a large amount of the liquid exuding from foods can be rapidly absorbed, distributed and securely stored.

Another object of the present invention is to provide an absorbent pad for the liquid exuding from foods, which can prepare more easily, and contains an antibacterial agent within an absorbent material layer and thus has an excellent antibacterial activity.

To achieve the above objects, one embodiment of the present invention provides an absorbent pad for absorbing the liquid exuding from foods, which comprises an upper sheet, a lower sheet and an absorbent material layer placed in-between, wherein the absorbent material layer is made from a pulp, a thermally active fiber, an antibacterial agent and an absorbent resin and bonded to each other, and the absorbent resin is in at least one form selected from the group consisting of a short fiber, powder and granules.

In a preferred embodiment, the present invention provides the absorbent pad for absorbing the liquid exuding from foods, wherein the thermally active fiber is a bi-component fiber where two resins having different melting points are formed in a sheath-core or side-by-side cross-section configuration.

In a more preferred embodiment, the present invention provides the absorbent pad for the liquid exuding from foods, wherein the thermally active fiber is a bi-component fiber, which is produced by spinning polyethylene resin (PE) and polyester resin (PET), polyethylene resin (PE) and polypropylene resin (PP), polypropylene resin (PP) and polyester resin (PET), and modified polyester resin (modified PET) and polyester resin (PET), in various configurations.

In the present invention, the absorbent resin may be selected from the group consisting of a cross-linked sodium acrylate copolymer, a starch graft copolymer, a cross-linked carboxymethyl cellulose derivative, and a modified hydrophilic acrylate resin. The absorbent resin may be in the form of short fiber, which may be produced by melt-spinning the absorbent resin.

Moreover, in the present invention, the absorbent material layer contains an antibacterial agent therein. The antibacterial agent can effectively prevent the proliferation of bacteria harmful to the human body, such as Salmonella spp., thereby allowing the problem of food poisoning to be solved.

Meanwhile, the upper sheet is produced in such a manner as to be substantially fluid-impermeable, and the lower sheet is produced in such a manner as to be substantially fluid-permeable. The term “fluid” refers to any liquid phase materials including water. In this case, it is preferable that the upper sheet is either (i) a single-layered structure of a perforated mesh film, a waterproof film or a non-woven fabric, or (ii) a two-layered structure of a tissue layer laminated on the above (i), and the lower sheet is either (i) a single-layered structure of a non-woven fabric, or (ii) a two-layered structure of a tissue layer laminated on a non-woven fabric.

The reason why the upper sheet is fluid-impermeable is that the upper sheet will be in contact with foods, and thus, its surface dryness needs to be maintained, and a possibility for the content of the absorbent material layer to flow backward must be eliminated. Also, the reason why the lower sheet is fluid-impermeable is that the lower sheet acts to transfer fluid into the absorbent material layer.

Furthermore, pieces of the pulp and the absorbent short fibers in the absorbent material layer are preferably arranged in a direction generally perpendicular to the planes of the upper (and lower sheets. When the absorbent material layer comprises the pulp, the thermally active fiber and the absorbent resin (absorbent short fiber and/or powdery absorbent resin), it is preferable that the absorbent material layer contains 1-50% by weight of the thermally active fiber, and 5-50% by weight of the absorbent resin based on 100% by weight of the absorbent material layer.

An aspect of the present invention provides an absorbent pad for use in food processing or storage. The absorbent pad comprises: an upper sheet comprising a surface configured to place food material on; a lower sheet; an absorbent material layer placed between the upper and lower sheets; and the absorbent material layer comprising at least one absorbent material. At least one absorbent material may be in one or more forms selected from the group consisting of fiber, powder and granules.

In the above-described absorbent pad, the at least one absorbent material may be selected from the group consisting of pulp and an absorbent resin. The absorbent material layer may further comprise an antibacterial agent. The absorbent material layer may comprise the antibacterial agent in an amount from about 0.1 to about 5% of a total weight of the absorbent material layer. The antibacterial agent may be selected from the group consisting of a chitosan or a chitosan-silver mixture. The absorbent material layer may further comprise a thermally active fiber, wherein two or more pieces of the at least one absorbent material may be connected via pieces of the thermally modifiable fiber. The absorbent material layer may comprise the thermally active fiber in an amount from about 5 to about 50% of a total weight of the absorbent material layer. The thermally active fiber may comprise two or more component resins, and wherein the two or more component resins have substantially different melting points from one another. The thermally active fiber has one or more forms selected from the group consisting of a sheath-core configuration, a side-by-side configuration and a islands-in-the-sea configuration. The thermally active fiber comprise two or more component resins selected from the group consisting of polyethylene resin (PE), polyester resin (PET), polypropylene resin (PP) and modified polyester resin (modified PET).

In the above-described absorbent pad, the at least one absorbent material may be selected from the group consisting of a cross-linked sodium acrylate copolymer, a starch graft copolymer, a cross-linked carboxymethyl cellulose derivative and a modified hydrophilic acrylate resin. The absorbent pad may further comprise at least one of an upper lining layer and a lower lining layer, wherein the upper lining layer may be placed between the upper sheet and the absorbent material layer, and wherein the lower lining layer may be place between the absorbent material layer and the lower sheet. The at least one of the upper and lower lining layers may be made of pulp. Either of the upper and lower sheets may be in a form selected from the group consisting of a perforated mesh film, a waterproof film and a non-woven fabric. At least one of the upper and lower sheets may comprise an antibacterial agent. The lower sheet may comprise an antibacterial agent in an amount from about 0.1 to about 0.3% of a total weight of the lower sheet.

Still in the above-described absorbent pad, a substantial part of the at least one absorbent material may be arranged as extending in a direction substantially perpendicular to a plane of the surface of the upper sheet or a plane of a surface of the lower sheet. The substantial part constitute about 5% or more of a total weight of the at least one absorbent material. The substantial part constitute about 10% or more of a total weight of the at least one absorbent material. The at least one absorbent material may comprise pulp and an absorbent resin, and wherein the substantial part constitute about 5% or more of a total weight of the pulp. The at least one absorbent material may comprise pulp and an absorbent resin, and wherein the substantial part constitute about 40% or more of a total weight of the pulp. The planes of the surfaces of the upper and lower sheets may be substantially parallel. The absorbent material layer may comprise an absorbent resin in an amount from about 5 to about 50% of a total weight of the absorbent material layer.

Another aspect of the present invention provides a method of absorbing liquid from food. The method comprises: providing an absorbent pad; placing a food material on the surface of the upper sheet of the absorbent pad; and absorbing liquid exuded from the food material with the absorbent pad. The absorbent pad used in this method may be that described above.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a schematic cross-sectional view of an absorbent pad according to an embodiment of the present invention;

FIG. 2 is a schematic cross-sectional view of an absorbent pad according to an embodiment of the present invention, wherein an absorbent material layer comprises a pulp, a thermally active fiber, an antibacterial agent and an absorbent short fiber;

FIG. 3 is a schematic cross-sectional view of an absorbent pad according to another embodiment of the present invention, wherein an absorbent material layer comprises a pulp, a thermally active fiber, an absorbent short fiber, an antibacterial agent and a powdery absorbent resin; and

FIG. 4 is a schematic diagram showing a process of producing an absorbent pad according to an embodiment of the present invention.

### DETAILED DESCRIPTION OF THE PREFERRED EMBODIMENT

Hereinafter, the present invention will be described in detail with reference to the accompanying drawings.

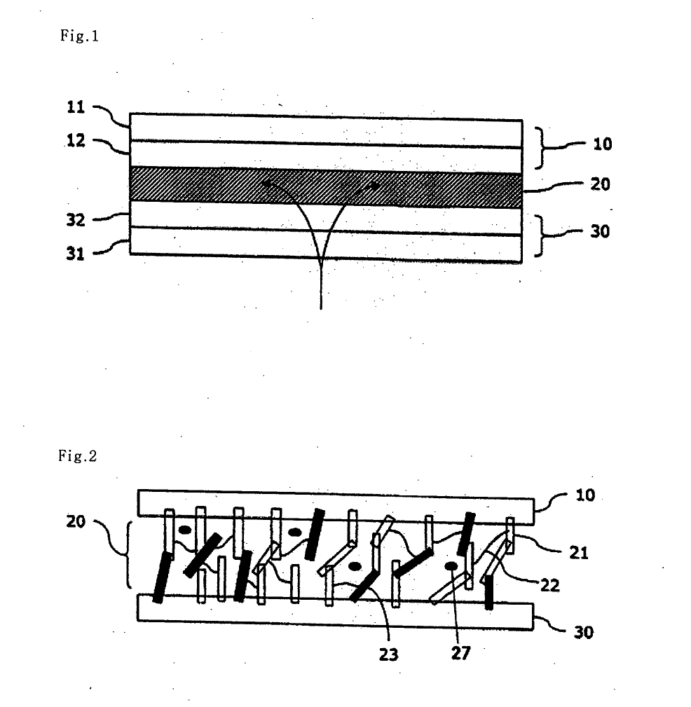

As shown in FIG. 1, an inventive absorbent pad comprises an upper sheet 10, a lower sheer 30, and an absorbent material layer 20 placed in-between.

Upon use of the absorbent pad, the upper sheet 10 is placed just below foods and comes in direct contact with the foods, and the lower sheet 30 comes in contact with the bottom of a food container. The upper sheet 10 may be formed in a single-layered structure made of a perforated mesh film, waterproof film or non-woven fabric 11. Alternatively, the upper sheet may be formed of a two-layered structure.

In the embodiment shown in FIG. 1, the upper sheet 10 is a two-layered structure having an outer layer 11 of a perforated mesh film, waterproof film or non-woven film, and a lining layer 12 laminated on the lower surface of the outer layer 11. The optional lining layer 12 in this embodiment is made of pulp although not limited thereto. The lining layer 12 helps prevent absorbent materials from flowing out of the absorbent material layer 20 toward foods.

In an embodiment of the present invention, the non-woven fabric 11 for use in the upper sheet 10 or the outer layer 11 can be produced using a short fiber by conventional processes, such as blending, opening, carding, bonding, slitting, winding and the like. The fiber forming the non-woven fabric for use in the outer layer 11 is a polyethylene fiber, a polypropylene fiber, a polyester fiber, a polyamide fiber, a rayon fiber, a polyurethane fiber, a cotton fiber, a hemp fiber, or a bi-component fiber thereof. The bi-component fiber can have a by-side-by cross-section configuration, a sheath-core cross-section configuration, or an islands-in-the-sea configuration, etc.

The lower sheet 30 may be in a single-layered structure of a non-woven fabric. Alternatively, the lower sheet 30 may be in a two-layered structure. In the embodiment shown in FIG. 1, the lower sheet 30 is constructed as a two-layered structure having an outer layer 31 and a lining layer 32. The outer layer 31 is preferably made of a non-woven fabric. The lining layer 32 is laminated on the lower surface of the outer layer 31. The optional lining layer 32 in this embodiment is made of pulp although not limited thereto. Again the lining layer 32 help prevent the absorbent materials from flowing out of the absorbent pad.

FIG. 2 is a schematic cross-sectional view of an absorbent pad in accordance with one embodiment of the present invention. In this embodiment, the absorbent material layer 20 contains a number of pieces of pulp 21, thermally active fiber 22, an antibacterial agent 27 and absorbent short fiber 23. A substantial part of the pieces of the pulp 21 and the absorbent short fiber 23 in the absorbent material layer 20 are bound to one another by pieces of the thermally active fiber 22. In other words, the absorbent materials in the absorbent material layer 20 are bound to each other in various combinations, such as pulp-pulp, pulp-absorbent short fiber, absorbent short fiber-thermally active fiber, or pulp-thermally active fiber, by the thermally active fiber 22 acting as a binder.

As shown in FIG. 2, the pieces of the pulp 21 and absorbent short fiber 23 in the absorbent material layer 20 are shaped as generally extending in a longitudinal direction. In an embodiment, the longitudinally shaped pulp pieces are prepared by shredding a pulp sheet into rod-like pieces with a length from about 2 to about 5 mm and a width from about 0.05 to 0.2 mm with a milling machine. In the embodiment, the longitudinal direction of the pulp pieces 21 are preferably arranged in a direction generally perpendicular to at least one of the planes formed by the surfaces of the upper or lower sheets. A substantial amount of the rod-like pulp pieces are arranged generally perpendicular to a plane of the lower or upper surface of the pad by dropping from above the surface, preferably with negative air pressure from the bottom of the surface as discussed below with reference to FIG. 4. By this pulp arrangement, the liquid exuding from foods is rapidly absorbed and stored in the absorbent material layer 20. The pulp pieces arranged in such a general direction may act as a conduit more efficiently than those arranged in different directions, and the liquid may be more rapidly absorbed and securely stored in the absorbent material layer 20.

The thermally active fiber 22 used in this embodiment is a bi- or multi-component fiber, preferably in a short fiber form although not limited to such form. The length of the thermally active fiber is from about 3 to about 15 μgm. The thermally active fiber 22 is typically produced by spinning two or more resins, for example, various combinations of polyethylene resin (PE) and polyester resin (PET), polyethylene resin (PE) and polypropylene resin (PP), polypropylene resin (PP) and polyester resin (PET), and modified polyester resin (modified PET) and polyester resin (PET), in various configurations.

The configurations of the bi-component fiber include: a sheath-core configuration where one component is located at a central or eccentric position of a fiber cross-section and the other component is placed around the central component; and a side-by-side configuration where two components are alternately arranged side-by-side, and the like.

The thermally active fiber 22 includes a bi- or multi-component fiber having two or more components, each of which preferably has a different melting point from that of the other(s). The melting point or temperature of each or at least one of the components is in the range of about 90° C. to about 170° C. One or more components of the fiber have a relatively low melting point, for example, from about 90° C to about 130° C. On or more other components of the fiber have a relatively high melting point, for example, from about 140° C. to about 170° C. At a temperature sufficient to melt the low-melting point component(s), such component(s) is melted to bond various ingredients of the absorbent material layer 20 while the component(s) with a relatively high melting point maintains the structure of the fiber 22.

In an embodiment, the absorbent short fiber 23 is produced by melting-spinning a powdery or granular absorbent resin and then cutting the spun filament into a smaller size. The resulting absorbent short fiber is called short-cut fiber for the sake of convenience. In another embodiment, the absorbent short fiber 23 is spun yarn, which is a strand of twisted threads produced by treating the short-cut fiber or other absorbent fiber. As such, the absorbent short fiber 23 is preferably made of an absorbent resin. The length of the absorbent short fiber 23 is typically from about 5 to about 15 mm, although not limited thereto.

The absorbent resin, which is used in the production of the absorbent short fiber 23, is a cross-linked sodium acrylate copolymer, a starch graft copolymer, a cross-linked carboxymethyl cellulose derivatives or a modified hydrophilic acrylate, etc. In an example of an embodiment of the present invention, a fiber commercially available under the trademark OASIS from Whilst Technical Absorbent Ltd., is used as the absorbent short fiber 23.

One embodiment of the present invention is characterized in that all of the pulp 21, the thermally active fiber 22 and the absorbent short fiber 23 in the absorbent material layer 20 are generally in a linear or longitudinal shape although not exactly linear. Other embodiments of the pad have these components of the absorbent material layer 20 in the linear shape and/or other shapes in the form of powder or granules. Also, a significant portions of the materials are randomly bonded with one anothe by means of the thermally active fiber 22. For this reason, in this embodiment, the materials are not likely to flow out of the absorbent pad even when they swell by absorbing the significant amount of liquid.

Meanwhile, in an embodiment of the absorbent pad of the present invention contains an antibacterial agent therein. As the antibacterial agent, an organic or inorganic antibacterial agent is used. Examples of the organic antibacterial agent include organic copper compounds, organic zinc compounds, organic nitrogen compound and organic silicone quaternary ammonium salts. More concrete examples include isothiazoline compounds and pyrithione compounds. Examples of the inorganic antibacterial agent include substituted metal ions having an excellent antibacterial activity, such as silver, copper, or zinc ions, which are supported on an inorganic carrier, such as zeolite, silica or alumina. Chitosan or a chitosan-silver mixture is preferably used.

The antibacterial agent 27 in the absorbent material layer 20 of the absorbent pad is preferably contained at the amount of 0.1-5.0% by weight. Meanwhile, in order to further increase the antibacterial activity of the absorbent pad, the antibacterial agent may also be contained in the upper sheet 10 and/or the lower sheet 30 at the amount of 0.1-3.0% by weight. However, since the upper sheet will be in contact with foods and thus must satisfy sanitary requirements and the absorbent material layer 20 contains the antibacterial agent 27, it is believed that, even if the antibacterial agents are contained only in the lower sheet 30, sufficient antibacterial effect is obtained.

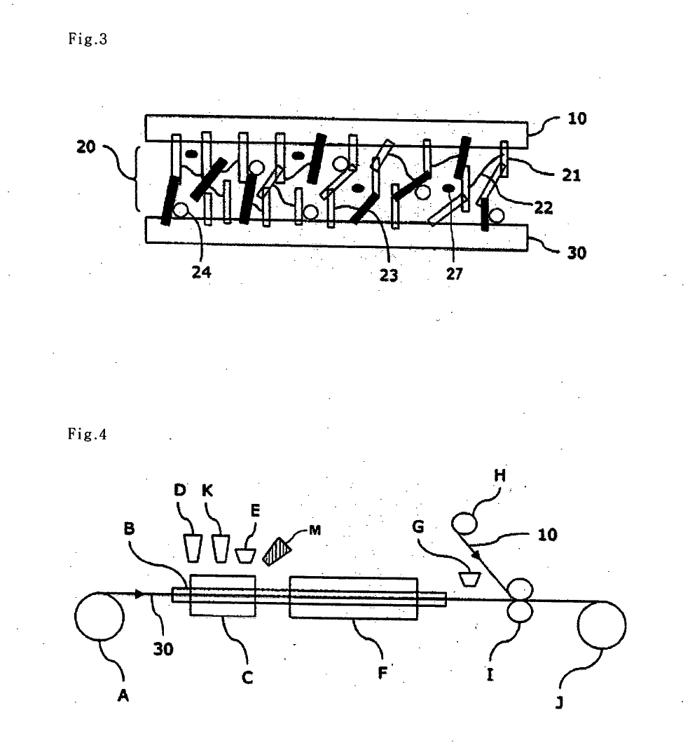

FIG. 3 shows a schematic cross-sectional view of an absorbent pad according to another embodiment of the present invention, in which the absorbent material layer 20 contains the pulp 21, the thermally active fiber 22, the absorbent short fiber 23, the antibacterial fiber 27 and the powdery absorbent resin 24. This absorbent pad is the same as the absorbent pad described above except that the absorbent short fiber and the powdery absorbent resin are used together, and thus, its detailed description will be omitted here. An example of the powdery absorbent resin, which is used in this embodiment, is FAVOR PAC 100™ manufactured by Stockhausen, which satisfies the requirements of FDA CFR21 part 177-1211.

An embodiment of a process of producing the inventive absorbent pad will now be described hereinafter with reference to FIG. 4. FIG. 4 is a schematic diagram showing a process of producing the inventive absorbent pad.

As shown in FIG. 4, the present invention further provides a system for producing absorbent pads. The system of FIG. 4 includes: a lower sheet feed roller A; a pulp feeder D, a thermally active fiber feeder E and an absorbent short fiber feeder K, which are disposed above a drum former D; an antibacterial agent feeder M; an upper sheet feed roller H; and the like. First, the rod-like pulp pieces (crushed pulp), the thermally active fiber and the absorbent short fiber are uniformly distributed in the respective feeders D, E and K above the lower sheet 30 continuously fed by the lower sheet feed roller A, to form the absorbent material layer 20 on the lower sheet 30. Then, the antibacterial agent 27 is placed on the absorbent material layer by an antibacterial agent feeder M, and subsequently, dried in a dryer F.

Then, the upper sheet 10, which is continuously fed by the upper sheet feed roller H, is laminated on the dried lower sheet 30 and the absorbent material layer 20, and heated and pressed with a nip roller I, thereby producing an absorbent pad of the present invention. In this process, the present invention is characterized in that the lower portion (mesh belt portion) of the drum former C is depressurized to 100-600 mmHg such that the pulps are arranged longitudinally in a direction substantially perpendicular to at least one of the planes of the upper and lower sheets.

As described above, the upper sheet is characterized in that it is made either of a single-layered structure of a non-woven fabric, a mesh film or a waterproof film, or of a two-layered structure of a tissue layer laminated on the above single layer. The lower layer is characterized in that it is made either of a single-layered structure of a non-woven fabric, or of a two-layered structure of a tissue layer laminated on the single layer.

As described above, since the absorbent pad contains the antibacterial agent therein and comprises the porous, liquid-impermeable non-woven fabrics, it has an excellent antibacterial activity and a high absorption rate. Thus, the absorbent pad can maintain the foods being stored, at a fresh state for an extended period of time.

The absorbent pad of an embodiment of the present invention was evaluated in terms of various physical properties according to the following method.

Test of Antibacterial Activity

Food (chicken meat) was placed on the absorbent pad in a state where it is wrapped and left to stand for 3 days. Then, the absorbent pad was removed and cultured in a 37° C. incubator for 24 hours, and the total colony count of the cultured absorbent pad was measured.

Measurement of Permeation Time of Liquid Exuding from Food (Chicken Meat)

8 g of the liquid exuding from food (chicken meat) was put into an absorbent pad with a width of 7 cm and a length of 20 cm, and the time taken for the liquid to be completely absorbed into the absorbent pad was measured. As the measured value becomes low, the surface absorbability and permeability of the absorbent pad for the liquid exuding from food are regarded as excellent.

Measurement of Surface Dryness of Absorbent Pad for Liquid Exuding from Food (Chicken Meat)

8 g of the liquid exuding from food (chicken meat) was completely absorbed into a 7 cm wide and 20 cm long absorbent pad. Then, the absorbent pad was left to stand at room temperature for 10 minutes, and five filter papers were put on the absorbent pad and pressurized to 0.3 psi. The amount of the liquid stained on the filter papers was recorded. The recorded value becomes low, the surface dryness is regarded as excellent.

The present invention will hereinafter be described in further detail by examples and comparative examples. It should however be borne in mind that the present invention is not limited to or by the examples.

### EXAMPLE 1

First, the tissue 32 was laminated on the non-woven fabric 31 to produce the lower sheet 30. Meanwhile, the tissue 12 was laminated on the waterproof film 11 to produce the upper sheet 10. Then, the lower sheet 30 was continuously fed by the lower sheet feeder roller A in such a manner that the tissue 32 faces upward and the non-woven fabric 31 faces downward. At the same time, on the lower sheet 30, 60.5% by weight, based on 100% by weight of the absorbent material layer, of the pulp, 8% by weight of the thermally active fiber, 30% by weight of absorbent short fibers (OASIS FIBER manufactured by Whilst Technical Absorbent Ltd.) and 1.5% by weight of the antibacterial agent were distributed by the pulp feeder D, the thermally active feeder E, the absorbent short fiber feeder K and the antibacterial feeder M which are placed above the drum former C, thereby forming the absorbent material layer 20. Then, the resulting lower sheet was dried in a dryer F. Here, the lower portion of the drum former C was depressurized to 300 mmHg such that the pulps were arranged longitudinally in a direction substantially perpendicular to at least one of the planes of the upper and lower sheets 10, 30. As the thermally active fiber, a bi-component fiber where polyethylene resin and polyester resin had been spun in a sheath-core configuration was used. As the antibacterial agent 27, liquid where antibacterial solution (ChitoFix silver) and distilled water had been mixed at the weight ratio of 1:9 was used. Subsequently, the upper sheet 10 was laminated on the dried lower sheet 30, and heated and pressed with the nip roller I to produce an absorbent pad. In laminating the upper pad 10 on the lower sheet 30, the upper sheet 10 was fed in such a manner that the waterproof film 11 faces upward and the tissue 12 faces downward. The produced absorbent pad was evaluated in terms of various physical properties and the results are given in Table 2 below.

### EXAMPLE 2

The procedure of Example 1 was repeatedly performed except that 65% by weight, based on 100% by weight of the absorbent material layer, of the pulp, 8% by weight of the thermally active fiber, 25% by weight of the absorbent short fiber and 2% by weight of the antibacterial agent were used to form the absorbent material layer 20.

### EXAMPLE 3

The procedure of Example 1 was repeatedly preformed except that 71.5% by weight, based on 100% by weight of the absorbent material layer, of the pulp, 9% by weight of the thermally active fiber, 18% by weight of the absorbent short fiber and 1.5% by weight of silver-based zeolite as the antibacterial agent were used to form the absorbent material layer 20.

### EXAMPLE 4

The procedure of Example 1 was repeatedly performed except that a sheet produced by laminating the perforated mesh film 11 on the tissue 12 was used as the upper sheet, and 67% by weight, based on 100% by weight of the absorbent material layer, of the pulp, 8% by weight of the thermally active fiber, 25% by weight of the absorbent short fiber and 2% by weight of silver-based zeolite as the antibacterial agent were used to form the absorbent material layer 20.

### EXAMPLE 5

First, the lower sheet 30 made of a single-layered structure of the non-woven fabric 31 was provided, and the non-woven fabric 11 was laminated on the tissue 12 to produce the upper sheet 10. Then, the lower sheet 30 was continuously fed by the lower sheet feeder roller A. At the same time, on the lower sheet 30, 58.5% by weight, based on 100% by weight of the absorbent material layer, of the pulp, 8% by weight of the thermally active fiber, 31% by weight of the absorbent short fiber and 3.5% by weight of the antibacterial agent (silver-based zeolite) were distributed by the pulp feeder D, the thermally active feeder E, the absorbent short fiber feeder K and the antibacterial agent feeder M which are placed above the drum former C, thereby forming the absorbent material layer 20. Then, the resulting lower sheet 30 was dried in a dryer F. Here, the lower portion of the drum former C was depressurized to 300 mmHg such that the pulps were arranged substantially longitudinally in a direction substantially perpendicular to at least one of the upper and lower sheets 10, 30. As the absorbent short fiber, a short fiber of acrylate resin was used. Subsequently, the upper sheet 10 was laminated on the dried lower sheet 30, and heated and pressed with the nip roller I to produce an absorbent pad. The produced absorbent pad was evaluated in terms of various physical properties and the results are given in Table 2 below.

### EXAMPLE 6

First, the tissue 32 was laminated on the non-woven fabric 31 to produce the lower sheet 30, and the tissue 12 was laminated on the non-woven fabric 11 to produce the upper sheet 10. Then, the lower sheet 30 was continuously fed by the lower sheet feeder roller A. At the same time, on the lower sheet 30, 59.5% by weight, based on 100% by weight of the absorbent material layer, of the pulp, 8% by weight of the thermally active fiber, 15% by weight of the absorbent short fiber, 15% by weight of the powdery absorbent resin (FAVOR PAC 100 manufactured by Stockhausen) and 2.5% by weight of the antibacterial agent (silver-based zeolite) were distributed by the pulp feeder D, the thermally active feeder E, the absorbent short fiber feeder K and the antibacterial agent feeder M which are placed above the drum former C, thereby forming the absorbent material layer 20. Then, the resulting lower sheet 30 was dried in a dryer F. Here, the lower portion of the drum former C was depressurized to 300 mmHg such that the pulps were substantially a longitudinally arranged in a direction substantially perpendicular to the planes of the upper and lower sheets 10, 30. As the absorbent short fiber, a short fiber of acrylate resin was used. Subsequently, the upper sheet 10 was laminated on the dried lower sheet 30, and heated and pressed with the nip roller I to produce an absorbent pad. The produced absorbent pad was evaluated in terms of various physical properties and the results are given in Table 2 below.

### EXAMPLE 7

First, the upper sheet 10 of a single-layered structure of non-woven fabric, and the lower sheet 30 of a single-layered structure of non-woven fabric, were provided. Then, the lower sheet 30 was continuously fed by the lower sheet feeder roller A. At the same time, on the lower sheet 30, 58% by weight, based on 100% by weight of the absorbent material layer, of the pulp, 8% by weight of the thermally active fiber, 30% by weight of the absorbent short fiber and 4% by weight of the antibacterial agent (silver-based zeolite) were distributed by the pulp feeder D, the thermally active feeder E, the absorbent short fiber feeder K and the antibacterial agent feeder M which are placed above the drum former C, thereby forming the absorbent material layer 20. Then, the resulting lower sheet 30 was dried in a dryer F. Here, the lower portion of the drum former C was depressurized to 300mmHg such that the pulps were substantially longitudinally arranged in a direction substantially perpendicular to the planes of the upper and lower sheets 10, 30. As the thermally active fiber, a bi-component fiber where polyethylene resin and polyester resin had been spun in a sheath-core configuration was used. Subsequently, the upper sheet 10 was laminated on the dried lower sheet 30, and heated and pressed with the nip roller I to produce an absorbent pad. The produced absorbent pad was evaluated in terms of various physical properties and the results are given in Table 2 below.

### COMPARATIVE EXAMPLE 1

The tissue 32 was laminated on the non-woven fabric untreated with the antibacterial agent to produce the lower sheet 30. Meanwhile, the tissue 12 was laminated on the waterproof film 11 to produce the upper sheet 10. Then, the lower sheet 30 was continuously fed by the lower sheet feeder roller A in such a manner that the tissue 32 faces upward and the waterproof film 31 faces downward. On the lower sheet 30, 67% by weight, based on 100% by weight of the absorbent material layer, of the pulp and 33% by weight of the powdery absorbent resin were distributed by the pulp feeder D and the powdery absorbent resin feeder which are placed above the drum former C, thereby forming the absorbent material layer 20. Then, the resulting lower roller was dried in the dryer F. Here, the lower portion of the drum former C was not depressurized such that the pulps were randomly arranged. As the absorbent resin, powdery carboxymethylcellulose was used. Subsequently, the upper sheet 10 was laminated on the dried lower sheet 30, and heated and pressed with the nip roller I to produce an absorbent pad. In laminating the upper pad 10 on the lower sheet 30, the upper sheet 10 was fed in such a manner that the waterproof film 11 faces upward and the tissue 12 faces downward. The produced absorbent pad was evaluated in terms of various physical properties and the results are given in Table 2 below.

### COMPARATIVE EXAMPLE 2

The tissue 12 was laminated on the perforated polypropylene mesh film 11 untreated with antibacterial agents to produce the upper sheet 10. Meanwhile, the tissue 32 was laminated on the waterproof film 31 to produce the lower sheet 30. Then, the lower sheet 30 was continuously fed by the lower sheet feeder roller A in such a manner that the tissue 32 faces upward and the waterproof film 31 faces downward. On the lower sheet 30, 75% by weight, based on 100% by weight of the absorbent material layer, of the pulp and 25% by weight of the powdery absorbent resin were distributed by the pulp feeder D and the powdery absorbent resin feeder which are placed above the drum former C, thereby forming the absorbent material layer 20. Then, the resulting lower roller was dried in the dryer F. Here, the lower portion of the drum former C was not depressurized such that the pulps were randomly arranged. As the absorbent resin, a granular acrylate sodium salt was used. Subsequently, the upper sheet 10 was laminated on the dried lower sheet 30, and heated and pressed with the nip roller I to produce an absorbent pad. In laminating the upper pad 10 on the lower sheet 30, the upper sheet 10 was fed in such a manner that the waterproof film 11 faces upward and the tissue 12 faces downward.

The structures of the upper and lower sheets, whether the antibacterial agent is contained in the absorbent pad or not and the composition of the absorbent material layer, in the absorbent pads produced according to Examples 1 to 7 and Comparative Examples 1-2, are given in Table 1 below.

The produced absorbent pad was evaluated in terms of various physical properties and the results are summarized in Table 1 below. Various physical properties evaluated for the absorbent pads are given in Table 2 below.

TABLE 1

| | | | | | | | | Com. | Com. |
|---|---|---|---|---|---|---|---|---|---|
| | Ex. 1 | Ex. 2 | Ex. 3 | Ex. 4 | Ex. 5 | Ex. 6 | Ex. 7 | Ex. 1 | Ex. 2 |
| A | 60.5 | 65 | 71.5 | 65 | 58.5 | 59.5 | 58 | 67 | 75 |
| B | 8 | 8 | 9 | 8 | 8 | 8 | 8 | | |
| C | 30 | 25 | 18 | 25 | 30 | 15 | 30 | | |
| D | | | | | | 15 | | 33 | 25 |
| E | Chitosan | Chitosan | Silver- | Silver- | Silver- | Silver- | Silver- | | |
| | 1.5 wt % | 2.0 wt % | based, | based, | based, | based, | based, | | |
| | | | 1.5 wt % | 2.0 wt % | 3.5 wt % | 2.5 wt % | 4.0 wt % | | |
| F | # | # | # | # | # | # | # | — | — |

Note:
A: Pulps;
B: Thermally active fibers;
C: Absorbent short fibers;
D: Powdery absorbent fibers;
E: Antibacterial agents;
F: Characteristic (#: Depressurized; —: Not depressurized)
Upper sheet of two-layered film: Ex. 1 to 3, and Com. Ex. 1 and 2 - Upper sheet of two-layered perforated PE: Ex. 4
Upper sheet of two-layered non-woven fabric: Ex. 5 and 6
Upper sheet of one-layered non-woven fabric: Ex. 7
Lower sheet of two-layered non-woven fabric: Ex. 1 to 4, Ex. 6, and Com. Ex. 1
Lower sheet of one-layered non-woven fabric: Ex. 5 and 7
Lower sheet of two-layered film: Com. Ex. 2

The amounts of the pulp, the thermally active fiber, the absorbent short fiber, the antibacterial agent and the powdery absorbent resin are given in % by weight based on 100% by weight of the absorbent material layer.

TABLE 2
Results of physical properties measured for absorbent pads

| | Antibacterial | Permeation | Surface | |
|---|---|---|---|---|
| | activity¹⁾ | time (sec)²⁾ | dryness (g)³⁾ | Flowing out⁴⁾ |
| Example 1 | 60 | 67 | 1.6 | Not occurred |
| Example 2 | 40 | 60 | 2.0 | Not occurred |
| Example 3 | 50 | 55 | 2.3 | Not occurred |
| Example 4 | 42 | 70 | 1.9 | Not occurred |
| Example 5 | 30 | 67 | 1.7 | Not occurred |
| Example 6 | 35 | 70 | 1.6 | Not occurred |
| Example 7 | 27 | 62 | 1.8 | Not occurred |
| Comparative | 13,000 | 85 | 2.8 | Occurred |
| Example 1 | | | | |
| Comparative | 15,000 | 80 | 3.0 | Occurred |
| Example 2 | | | | |

Note)
¹⁾(antibacterial activity): colony forming units (CFU/ml).
²⁾(permeation time) and
³⁾(surface dryness): measured for the liquid exuding from food (chicken meat).
⁴⁾(flowing out): determined if the absorbent materials have flowed out of the absorbent pad or not. For this purpose, the produced absorbent pad was placed beneath frozen chicken meat and left to stand below −5° C. for 5 days, and then whether the absorbent materials had flowed out of the absorbent pad or not was confirmed visually and evaluated.

From the measurement results, it can be thought that the higher the content of the antibacterial agent becomes, the higher the antibacterial activity becomes.

Regarding the permeation time, the absorbent short fibers show a higher absorption rate than the absorbent powdery resin, and the lower the amount of the absorbent resin relative to the pulp is, the higher the absorption rate is. Furthermore, it can be seen that the non-woven fabric pulp shows a higher absorption rate than the perforated polyethylene resin, and the tissue in the upper sheet results in a reduction in the absorption rate, but an increase in the surface dryness.

In addition, it can be found that the surface dryness is increased both in the presence of the tissue and with an increase in the amount of the absorbent materials.

As described above, according to the present invention, the absorbent materials can be effectively prevented from flowing out of the absorbent pads even when the absorbent pad swells by absorbing the liquid exuding from foods. Thus, the absorbent pad of the present invention allows the freshness of foods to be maintained for an extended period of time and also can prevent the foods from being damaged by the absorbent materials flowed out of the absorbent pad. Furthermore, the absorbent pad of the present invention has an excellent antibacterial activity, and can more rapidly absorb the fluid exuding from foods, so that it allows the foods to be kept in more sanitary conditions.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. An absorbent pad for use in food processing or storage, comprising:
an upper sheet comprising a surface configured to place food material on;
a lower sheet;
an absorbent material layer placed between the upper and lower sheets; and
the absorbent material layer comprising pulp and at least one absorbent resin, wherein the at least one absorbent resin is in one or more forms selected from the group consisting of fiber, powder and granules.

2. The absorbent pad of claim 1, wherein the absorbent material layer further comprises an antibacterial agent in an amount from about 0.1 to about 5% of a total weight of the absorbent material layer.

3. The absorbent pad of claim 2, wherein the antibacterial agent is selected from the group consisting of a chitosan and a chitosan-silver mixture.

4. The absorbent pad of claim 1, wherein the absorbent material layer further comprises a thermally active fiber, wherein two or more pieces of the at least one absorbent material are connected via one or more pieces of the thermally modifiable fiber.

5. The absorbent pad of claim 4, wherein the thermally active fiber is in an amount from about 5 to about 50% of a total weight of the absorbent material layer.

6. The absorbent pad of claim 4, wherein the thermally active fiber comprises two or more component resins, and wherein the two or more component resins have substantially different melting points from one another.

7. The absorbent pad of claim 4, wherein the thermally active fiber has one or more forms selected from the group consisting of a sheath-core configuration, a side-by-side configuration and a islands-in-the-sea configuration.

8. The absorbent pad of claim 4, wherein the thermally active fiber comprise two or more component resins selected from the group consisting of polyethylene resin (PE), polyester resin (PET), polypropylene resin (PP) and modified polyester resin (modified PET).

9. The absorbent pad of claim 1, wherein the at least one absorbent resin is selected from the group consisting of a cross-linked sodium acrylate copolymer, a starch graft copolymer, a cross-linked carboxymethyl cellulose derivative and a modified hydrophilic acrylate resin.

10. The absorbent pad of claim 1, wherein either of the upper and lower sheets is in a form selected from the group consisting of a perforated mesh film, a waterproof film and a non-woven fabric.

11. The absorbent pad of claim 1, wherein at least one of the upper and lower sheets comprises an antibacterial agent in an amount from about 0.1 to about 0.3 % of a total weight of the lower sheet.

12. The absorbent pad of claim 1, wherein a substantial part of the at least one absorbent material is arranged as extending in a direction substantially perpendicular to a plane of the surface of the upper sheet or a plane of a surface of the lower sheet.

13. The absorbent pad of claim 12, wherein the substantial part constitutes about 5% or more of a total weight of the at least one absorbent material.

14. The absorbent pad of claim 12, wherein the planes of the surfaces of the upper and lower sheets are substantially parallel.

15. The absorbent pad of claim 1, wherein the absorbent resin is in an amount from about 5 to about 50% of a total weight of the absorbent material layer.

16. A method of absorbing liquid from food, comprising:
providing the absorbent pad of claim 1;
placing a food material on the surface of the upper sheet of the absorbent pad; and
absorbing liquid exuded from the food material with the absorbent pad.

17. The method of claim 16, wherein the absorbent material layer further comprises an antibacterial agent in an amount from about 0.1 to about 5% of a total weight of the absorbent material layer.

18. The method of claim 16, wherein the absorbent material layer further comprises a thermally active fiber, and wherein two or more pieces of the at least one absorbent material are connected via one or more pieces of the thermally modifiable fiber.

19. The method of claim 16, wherein the thermally active fiber has one or more forms selected from the group consisting of a sheath-core configuration, a side-by-side configuration and a islands-in-the-sea configuration, and wherein the thermally active fiber comprises two or more component resins selected from the group consisting of polyethylene resin (PE), polyester resin (PET), polypropylene resin (PP) and modified polyester resin (modified PET).

20. The method of claim 16, wherein the at least one absorbent material is selected from the group consisting of a cross-linked sodium acrylate copolymer, a starch graft copolymer, a cross-linked carboxymethyl cellulose derivative and a modified hydrophilic acrylate resin.
